(19) United States
(12) Patent Application Publication
(10) Pub. No.: US 2019/0030793 A1
(43) Pub. Date: Jan. 31, 2019

(54) THREE-DIMENSIONAL PRINTING DEVICE AND METHOD FOR PRINTING THREE-DIMENSIONAL OBJECT

(71) Applicant: Roland DG Corporation, Hamamatsu-shi (JP)

(72) Inventor: Fumiyoshi IWASE, Hamamatsu-shi (JP)

(21) Appl. No.: 16/044,560

(22) Filed: Jul. 25, 2018

(30) Foreign Application Priority Data
Jul. 28, 2017 (JP) 2017-146096

(51) Int. Cl. B29C 64/165; B33Y 70/00; B29C 64/255; B33Y 10/00

(52) U.S. Cl. CPC B29C 64/165; B33Y 10/00; B29C 64/255; B33Y 70/00

(57) ABSTRACT

A three-dimensional printing device includes a layer former that levels off a supplied powder material to form a powder layer including a flat portion having a predetermined height on a printing table, and a supply amount setter that sets an amount of the powder material to be supplied. The supply amount setter sets, as the amount of the powder material to be supplied, an amount smaller than a reference supply amount corresponding to a volume determined as a result of an area size of the printing table being multiplied by the predetermined height. If an amount smaller than the reference supply amount is set as the amount of the powder material to be supplied, the layer former forms the powder layer having the flat portion such that the flat portion has an area size smaller than the area size of the printing table.

### CROSS REFERENCE TO RELATED APPLICATION

This application claims the benefit of priority to Japanese Patent Application No. 2017-146096 filed on Jul. 28, 2017. The entire contents of this application are hereby incorporated herein by reference.

### BACKGROUND OF THE INVENTION

### 1. Field of the Invention

The present invention relates to a three-dimensional printing device and a method for printing a three-dimensional object.

### 2. Description of the Related Art

Conventionally, a powder stack method of ejecting a binder toward a powder material and curing the powder material to print a desired three-dimensional object is disclosed in Japanese Patent No. 5400042.

A three-dimensional printing device disclosed in Japanese Patent No. 5400042 includes a printer portion accommodating powder, a powder supplier accommodating the powder to be supplied to the printer portion, and an inkjet head located above the printer portion. The inkjet head ejects aqueous ink toward the powder accommodated in the printer portion. More specifically, the inkjet head ejects the aqueous ink toward a portion of the powder accommodated in the printer portion, which corresponds to a cross-sectional shape of the three-dimensional object. The portion of the powder accommodated in the printer portion to which the aqueous ink is ejected is cured to form a cured layer corresponding to the cross-sectional shape. Such cured layers are sequentially stacked to print a desired three-dimensional object.

A three-dimensional printing device prints various sizes of three-dimensional objects. Often times, the size of the three-dimensional object to be printed is significantly smaller than the size of a printing table on which the printing is performed. In such a case, it is sufficient that a powder layer is formed in, and around, a region where the three-dimensional object is to be printed. The powder layer does not need to be formed in an outer region outside of a region where the three-dimensional object is printed. However, in a conventional three-dimensional printing device, the powder layer is always formed on the entirety of the printing table. Therefore, the same amount of powder material is always needed, even in the case where a relatively small three-dimensional object is to be printed. In the case where a large amount of powder material is used, a large amount of labor is needed to prepare for the printing and to perform processing after the printing. In addition, an uncured portion of the powder material is not all reusable, which increases the consumption and waste of the powder material.

### SUMMARY OF THE INVENTION

Preferred embodiments of the present invention provide three-dimensional printing devices that decrease the amount of powder material needed to perform printing, and methods for printing three-dimensional objects that decrease the amount of powder material needed to perform printing.

A three-dimensional printing device according to a preferred embodiment of the present invention cures a powder material to print a three-dimensional object. The three-dimensional printing device includes a printing table; a material supplier that supplies the powder material; a layer former that levels off the supplied powder material to form a powder layer including a flat portion having a predetermined height on the printing table; and a controller connected with the material supplier and the layer former. The controller is configured or programmed to include a supply controller that controls the material supplier such that the powder material is supplied; a formation controller that controls the layer former such that the powder layer is formed on the printing table; and a supply amount setter that sets an amount of the powder material to be supplied from the material supplier. The supply amount setter sets, as the amount of the powder material to be supplied, an amount smaller than a reference supply amount corresponding to a volume determined as a result of an area size of the printing table being multiplied by the predetermined height; and in a case where an amount smaller than the reference supply amount is set as the amount of the powder material to be supplied, the layer former forms the powder layer including the flat portion such that the flat portion has an area size smaller than the area size of the printing table.

A method for printing a three-dimensional object according to a preferred embodiment of the present invention is a method for printing a three-dimensional object by curing a powder material on a printing table. The method includes a first step of measuring the powder material; a second step of levelling off the measured powder material to form a powder layer including a flat portion having a predetermined height on the printing table; and a third step of curing the powder material of the powder layer to form the three-dimensional object. The amount of the powder material to be measured is smaller than an amount corresponding to a volume determined as a result of an area size of the printing table being multiplied by the predetermined height; the flat portion has an area size smaller than the area size of the printing table; and the three-dimensional object is formed by curing the powder material of the flat portion.

According to the three-dimensional printing device and a method for printing a three-dimensional object described in the preceding paragraphs, a powder layer including a flat portion smaller than the printing table as seen in a plan view is able to be formed. Thus, the powder layer may be formed on one region of the printing table, not on the entirety of the printing table. This eliminates the wasteful formation of the powder layer even on a region, on the printing table, where the three-dimensional object is not to be formed, and the amount of the powder material needed for the printing is able to be decreased.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view schematically showing a three-dimensional printing device according to preferred embodiment 1 of the present invention.

FIG. 2 is a plan view schematically showing the three-dimensional printing device in preferred embodiment 1 of the present invention.

FIG. 3 is a block diagram of the three-dimensional printing device in preferred embodiment 1 of the present invention.

FIG. 4 is a plan view of a printing table schematically showing the relationship between a powder layer and a three-dimensional object.

FIG. 5A is a schematic cross-sectional view of a printing tank, a supply tank and the vicinity thereof, showing a state before a powder material is moved.

FIG. 5B is a schematic cross-sectional view of the printing tank, the supply tank and the vicinity thereof, showing a state after a powder layer is formed.

FIG. 6 is a cross-sectional view schematically showing a three-dimensional printing device in preferred embodiment 2 of the present invention.

FIG. 7 is a cross-sectional view of the three-dimensional printing device taken along line VII-VII in FIG. 6.

FIG. 8 is a block diagram of the three-dimensional printing device in preferred embodiment 2 of the present invention.

FIG. 9 is a block diagram of a three-dimensional printing device in preferred embodiment 3 of the present invention.

FIG. 10 is a schematic view showing a formation region for the powder layer in preferred embodiment 3 of the present invention.

### DETAILED DESCRIPTION OF THE PREFERRED EMBODIMENTS

Hereinafter, preferred embodiments of three-dimensional printing devices according to the present invention will be described with reference to the drawings. The preferred embodiments described below are not intended to specifically limit the present invention. Components and portions that have the same functions will bear the same reference signs, and overlapping descriptions will be omitted or simplified.

### Preferred Embodiment 1

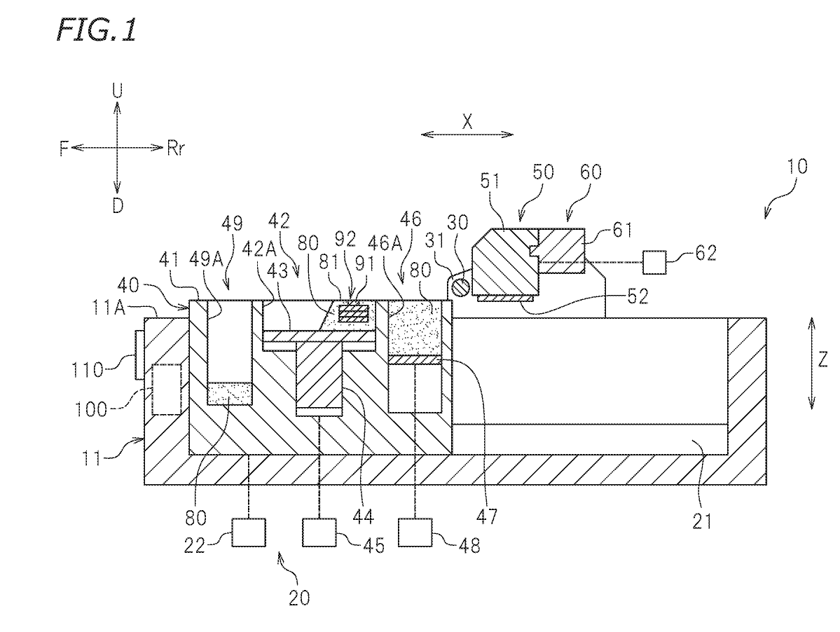

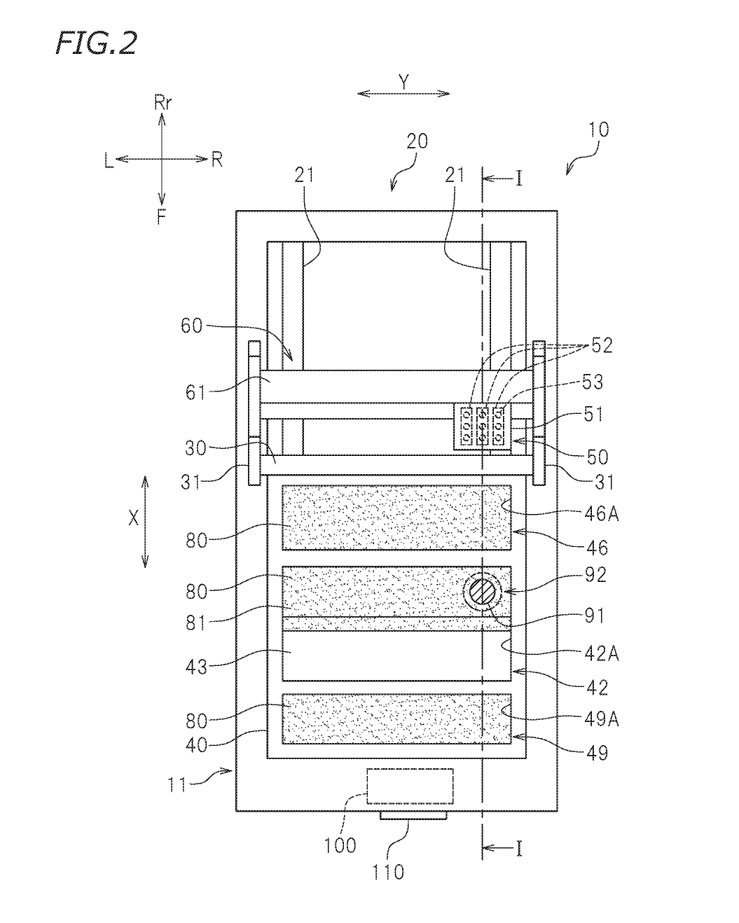

FIG. 1 is a cross-sectional view of a three-dimensional printing device 10 according to preferred embodiment 1. FIG. 2 is a plan view of the three-dimensional printing device 10 in this preferred embodiment. The cross-sectional view in FIG. 1 is taken along line I-I in FIG. 2. In FIG. 1, letter F represents “forward”, and letter Rr represent “rearward”. In this preferred embodiment, the terms “left”, “right”, “up” and “down” represent left, right, up and down as seen from a person who faces a front surface of the three-dimensional printing device 10. In the drawings, letters L, R, U and D respectively represent left, right, up and down. In this preferred embodiment, letters X, Y and Z respectively represent a front-rear direction, a left-right direction, and an up-down direction. The left-right direction Y is a scanning direction of the three-dimensional printing device 10. The front-rear direction X is a feeding direction of the three-dimensional printing device 10. The up-down direction Z is a stacking direction of the three-dimensional printing device 10. It should be noted that these directions are merely provided for the sake of convenience, and do not limit the manner of installation of the three-dimensional printing device 10 in any way.

As shown in FIG. 1, the three-dimensional printing device 10 in this preferred embodiment is a device that cures a powder material 80 with a curing liquid to form a cured layer 91 and sequentially and integrally stacks such cured layers 91 in the up-down direction Z to print a three-dimensional object 92. The three-dimensional printing device 10 in this preferred embodiment ejects the curing liquid toward the powder material 80 based on cross-sectional images representing cross-sectional shapes of the three-dimensional object 92 desired to be printed, and cures the powder material 80 to form the cured layers 91. The cured layers 91 are sequentially stacked to form the three-dimensional object 92 as desired.

Herein, the term “cross-sectional shapes” refers to shapes of cross-sections provided by slicing the three-dimensional object 92 to be printed at intervals of a predetermined thickness (e.g., at intervals of about 0.1 mm; the “predetermined thickness” is not limited to being one, same thickness) in a predetermined direction (e.g., in a horizontal direction).

There is no specific limitation on the composition, form or the like of the powder material. The powder material may be formed of any of various powder materials such as resin materials, metal materials, inorganic materials and the like. Examples of the powder material include ceramic materials such as alumina, silica, titania, zirconia and the like; iron, aluminum, titanium and alloys thereof (typically, stainless steel, titanium alloy, aluminum alloy); hemihydrate gypsum (α-calcined gypsum, β-calcined gypsum); apatite; salt; plastic materials; and the like. The powder material may be formed of one of these materials or a combination of two or more thereof.

The curing liquid is not limited to any particular liquid, and may be any liquid that fixes particles of the powder material to each other. An example of curing liquid is a liquid (encompassing viscous material) that fixes the particles of the powder material. The type of curing liquid varies in accordance with the type of the powder material. Examples of the curing liquid include liquids respectively containing water, wax, binder and the like. In the case where the powder material includes a water-soluble resin as a sub material, the curing liquid may be a liquid dissolving the water-soluble resin, for example, water. There is no specific limitation on the type of the water-soluble resin. For example, the water-soluble resin may be starch, polyvinylalcohol (PVA), polyvinylpirrolidone (PVP), water-soluble acrylic resin, water-soluble urethane resin, water-soluble polyamide or the like.

As shown in FIG. 1, the three-dimensional printing device 10 includes a main body 11, a feeding direction conveyor 20, a spreading roller 30, a printing tank unit 40, a head unit 50, a scanning direction conveyor 60, and a controller 100.

As shown in FIG. 2, the main body 11 includes an outer casing of the three-dimensional printing device 10 having a shape longer in the feeding direction X. The main body 11 has a box shape opened upward. The main body 11 accommodates the feeding direction conveyor 20, the printing tank unit 40 and the controller 100. As shown in FIG. 1, the main body 11 also defines and functions as a support table that supports the spreading roller 30 and the scanning direction conveyor 60.

As shown in FIG. 1, the printing tank unit 40 is accommodated in the main body 11. The printing tank unit 40 includes a printing tank 42, a printing table 43, a table elevator 45, a supply tank 46, a supply tank elevator 48, and an extra powder accommodation tank 49. A top surface 41 of the printing tank unit 40 is flat. The printing tank 42, the supply tank 46 and the extra powder accommodation tank 49 are provided independently side by side and recessed from the top surface 41.

As shown in FIG. 1, the printing tank 42 is included in the printing tank unit 40. The printing tank 42 is a tank in which the three-dimensional object 92 is printed. The printing tank 42 is provided with a printing space 42A accommodating the powder material 80. The printing space 42A is supplied with the powder material 80, so that the three-dimensional object 92 is printed in the printing space 42A.

As shown in FIG. 1, the printing table 43 is located in the printing space 42A of the printing tank 42. The powder material 80 is placeable on the printing table 43. The three-dimensional object 92 is printed on the printing table 43. The printing table 43 is movable in the up-down direction Z. As shown in FIG. 2, the printing table 43 is rectangular or substantially rectangular as seen in a plan view, for example. The printing table 43 is not limited to having a rectangular or substantially rectangular planar shape. The printing table 43 is provided with a table support 44. The table support 44 extends downward from a bottom surface of the printing table 43. The table support 44 is movable in the up-down direction Z integrally with the printing table 43.

The table elevator 45 moves the printing table 43 in the up-down direction Z. There is no specific limitation on the structure of the table elevator 45. In this preferred embodiment, the table elevator 45 includes a servo motor, a ball screw and the like (not shown). For example, the servo motor is connected with the table support 44, and is connected with the printing table 43 via the table support 44. The servo motor is driven to move the table support 44 in the up-down direction Z. Along with the movement of the table support 44 in the up-down direction Z, the printing table 43 is also moved in the up-down direction Z. The table elevator 45 is electrically connected with the controller 100, and is controlled by the controller 100.

The supply tank 46 is a tank in which the powder material 80 is stored before being supplied to the printing space 42A of the printing tank 42. As shown in FIG. 2, the supply tank 46 is rectangular or substantially rectangular as seen in a plan view, for example. The supply tank 46 is not limited to having a rectangular or substantially rectangular planar shape. The supply tank 46 accommodates a bottom 47 having the same shape as that of the supply tank 46 as seen in a plan view. The supply tank 46 and the bottom 47 define a storage space 46A accommodating the powder material 80. In the storage space 46A, the powder material 80 is stored before the printing is started. The powder material 80 in the storage space 46A is spread to fill the printing space 42A of the printing tank 42 by the spreading roller 30 described below. The supply tank 46 is located to the rear of the printing tank 42. The supply tank 46 is located at the same position as that of the printing tank 42 in the scanning direction Y. As shown in FIG. 2, as seen in a plan view, the length of the printing space 42A of the printing tank 42 in the scanning direction Y (i.e., length of the printing table 43 in the scanning direction Y) is equal substantially equal or to the length of the storage space 46A of the supply tank 46 in the scanning direction Y. Alternatively, the length of the storage space 46A in the scanning direction Y may be longer than the length of the printing space 42A in the scanning direction Y.

The bottom 47 is movable in the up-down direction Z in the supply tank 46. The supply tank elevator 48 is coupled to a bottom portion of the bottom 47. The supply tank elevator 48 moves the bottom 47 in the up-down direction Z. There is no specific limitation on the structure of the supply tank elevator 48. In this preferred embodiment, the supply tank elevator 48 includes a servo motor, a ball screw and the like (not shown), like the table elevator 45. The servo motor of the supply tank elevator 48 is driven to move the bottom 47 in the up-down direction Z. The supply tank elevator 48 is electrically connected with the controller 100, and is controlled by the controller 100.

The extra powder accommodation tank 49 is a tank that, in the case where the powder material 80 is spread to fill the printing tank 42 so as to have a flat surface by the spreading roller 30, recovers a portion of the powder material 80 that is not accommodated in the printing tank 42. The extra powder accommodation tank 49 is provided with an accommodation space 49A accommodating the powder material 80. The extra powder accommodation tank 49 is located to the front of the printing tank 42. The extra powder accommodation tank 49 is located at the same position with that of the printing tank 42 in the scanning direction Y. As shown in FIG. 2, as seen in a plan view, the length of the printing space 42A of the printing tank 42 in the scanning direction Y is equal or substantially equal to the length of the accommodation space 49A of the extra powder accommodation tank 49 in the scanning direction Y. Alternatively, the length of the accommodation space 49A in the scanning direction Y may be longer than the length of the printing space 42A in the scanning direction Y.

As shown in FIG. 1, the feeding direction conveyor 20 moves the printing tank unit 40 in the feeding direction X with respect to a head unit 50 and the spreading roller 30. In this preferred embodiment, the feeding direction conveyor 20 includes a pair of guide rails 21 and a feed motor 22.

As shown in FIG. 1, the guide rails 21 guide the movement of the printing tank unit 40 in the feeding direction X. The guide rails 21 are provided in the main body 11. The guide rails 21 extend in the feeding direction X. The printing tank unit 40 is slidably engaged with the guide rails 21. There is no specific limitation on the position or the number of the guide rails 21. The feed motor 22 is connected with the printing tank unit 40 via, for example, a ball screw or the like. The feed motor 22 is electrically connected with the controller 100. The feed motor 22 is driven to rotate, and as a result, the printing tank unit 40 is moved on the guide rails 21 in the feeding direction X.

The spreading roller 30 spreads the powder material 80, stored in the storage space 46A of the supply tank 46, to fill the printing space 42A. The spreading roller 30 levels off a surface of the powder material 80 to form a powder layer 81. The spreading roller 30 is located above the main body 11. The spreading roller 30 is located to the front of the head unit 50. The spreading roller 30 has a lengthy cylindrical shape. The spreading roller 30 is located such that the axis of the cylindrical shape is along the scanning direction Y. The length of the spreading roller 30 in the scanning direction Y is longer than the length of the printing space 42A of the printing tank 42 in the scanning direction Y. A bottom end of the spreading roller 30 is slightly above the printing tank unit 40 such that a predetermined clearance is formed between the spreading roller 30 and the top surface 41 of the printing tank unit 40. The spreading roller 30 is rotatably supported by a pair of supports 31 provided on the top surface 11A of the main body 11. The spreading roller 30 may rotate by, for example, a motor connected thereto.

As shown in FIG. 2, the head unit 50 includes a carriage 51 and a plurality of the ejection heads 52 mounted on the carriage 51. The plurality of ejection heads 52 are located on a bottom surface of the carriage 51. The ejection heads 52 are members that eject the curing liquid, which bonds the particles of the powder material 80 to each other, toward the powder material 80 placed on the printing table 43. The plurality of ejection heads 52 are arrayed in the scanning direction Y. The ejection heads 52 each include a plurality of nozzles 53, from which the curing liquid is to be ejected. As shown in FIG. 2, the plurality of nozzles 53 are arrayed in a straight line in the feeding direction X. There is no specific limitation on the mechanism by which the ejection heads 52 eject the curing liquid. The ejection heads 52 may be, for example, of an inkjet system. The ejection heads 52 are electrically connected with the controller 100. The ejection of the curing liquid from the nozzles 53 of the ejection heads 52 is controlled by the controller 100.

The scanning direction conveyor 60 moves the carriage 51 in the scanning direction Y. As shown in FIG. 2, the scanning direction conveyor 60 includes a guide rail 61. The guide rail 61 extends in the scanning direction Y. The carriage 51 is slidably engaged with the guide rail 61. A carriage motor 62 is connected with the carriage 51 via, for example, an endless belt and pulleys. The carriage motor 62 is driven to move the carriage 51 in the scanning direction Y along the guide rail 61. The carriage motor 62 is electrically connected with the controller 100. The carriage motor 62 is controlled by the controller 100. Along with the movement of the carriage 51 in the scanning direction Y, the plurality of ejection heads 52 are also moved in the scanning direction Y.

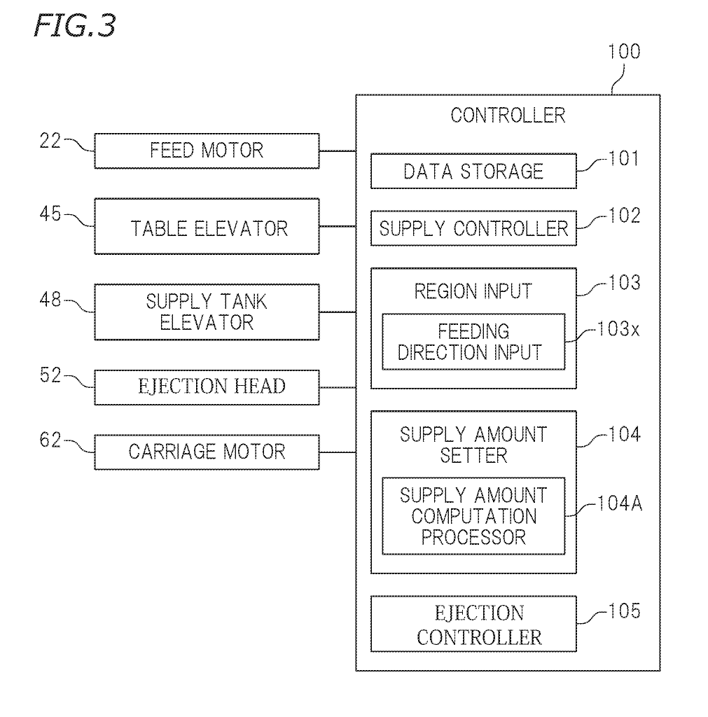

As shown in FIG. 1, an operation panel 110 is provided on a front surface of the main body 11. The operation panel 110 includes a display that displays the state of the three-dimensional printing device 10, input keys operable by a user, and the like. The operation panel 110 is connected with the controller 100 controlling various operations of the three-dimensional printing device 10. FIG. 3 is a block diagram of the three-dimensional printing device 10 in this preferred embodiment. As shown in FIG. 3, the controller 100 is communicably connected with, and is configured or programmed to control, the feed motor 22, the table elevator 45, the supply tank elevator 48, the ejection heads 52, and the carriage motor 62. The controller 100 is configured or programmed to include a data storage 101, a supply controller 102, a region input 103, a supply amount setter 104, and an ejection controller 105.

There is no specific limitation on the structure of the controller 100. The controller 100 is, for example, a microcomputer. There is no specific limitation on the hardware structure of the microcomputer. The controller 100 includes, for example, an interface (I/F) receiving printing data and the like from an external device such as a host computer or the like, a central processing unit (CPU) executing instructions of a control program, a ROM (read only memory) having stored thereon a program executable by the CPU, a RAM (random access memory) usable as a working area in which the program is developed, and a storage device such as a memory or the like storing the above-described program and various types of data. The controller 100 does not need to be provided in the three-dimensional printing device 10, and may be, for example, a computer that is installed outside the three-dimensional printing device 10 and is communicably connected with the three-dimensional printing device 10 in a wired or wireless manner.

The data storage 101 stores printing data on the three-dimensional object 92 to be printed. The printing data includes, for example, size data on the three-dimensional object 92, printing conditions set by use of the operation panel 110 or the like. The three-dimensional printing device 10 prints the three-dimensional object 92 based on the printing data stored on the data storage 101.

The supply controller 102 controls the feed motor 22, the table elevator 45 and the supply tank elevator 48 such that the powder layer 81 is formed on the printing table 43. The formation of the powder layer 81 will be described in detail below.

The region input 103 is a portion to which a region, of the printing table 43, in which the powder layer 81 is to be formed, is to be input. Such a region will be referred to as a “formation region of the powder layer 81”. As shown in FIG. 3, the region input 103 includes a feeding direction input 103x. To the feeding direction input 103x, a length of the powder layer 81 in the feeding direction X is to be input. In this preferred embodiment, a width of the powder layer 81 in the scanning direction Y is a width of the printing table 43 in the scanning direction Y like in a conventional three-dimensional printing device. The region input 103 causes an operation screen to be displayed on, for example, the operation panel 110, a display device of an external computer, or the like. The user inputs the length of the powder layer 81 in the feeding direction X to the displayed operation screen.

The supply amount setter 104 sets an amount of the powder material 80 to be supplied from the supply tank 46. The supply amount setter 104 includes a supply amount computation processor 104A. Based on the formation region of the powder layer 81 input to the region input 103, the supply amount computation processor 104A computes the amount of the powder material 80 needed to form the powder layer 81 in the formation region. The supply controller 102 supplies the powder material 80 in the amount set by the supply amount setter 104 from the supply tank 46.

The ejection controller 105 controls the feed motor 22, the ejection heads 52 and the carriage motor 62 such that the curing liquid is ejected to a desired position on the powder layer 81. The position to which the curing liquid is ejected is based on the printing data. The powder material 80 is cured by the curing liquid ejected from the ejection heads 52 to form the cured layer 91. On the cured layer 81 thus formed, another powder layer 81 is formed and is cured. In this manner, the cured layers 81 are stacked upward.

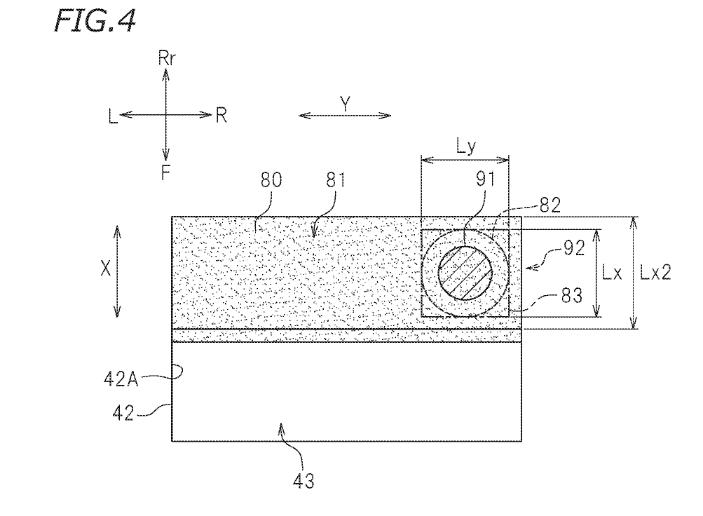

FIG. 4 is a plan view of the printing table 43 schematically showing the relationship between the powder layer 81 and the three-dimensional object 92. As shown in FIG. 4, one curing region 82 corresponds to one three-dimensional object 92. As seen in a plan view, the curing region 82 is a region, of the printing table 43, to which the curing liquid is to be ejected. The cured layers 91 forming one three-dimensional object 92 have various shapes. The curing region 82 encompasses all the cured layers 91. Namely, the curing region 82 matches a projection drawing of the three-dimensional object 92 projected in the up-down direction Z. In FIG. 4, “Lx” is the length of the curing region 82 in the feeding direction X. In FIG. 4, “Ly” is the length of the curing region 82 in the scanning direction Y. In FIG. 4, a rectangle (encompassing square) 83 is defined by a line segment having the length Lx extending in the feeding direction X and a line segment having the length Ly extending in the scanning direction Y, and circumscribes the curing region 82. The rectangle 83 is a minimum region to which the powder material 80 needs to be suppled in order to print the three-dimensional object 92. Hereinafter, the rectangle 83 will also be referred to as a “minimum printing region 83”.

As shown in FIG. 4, the minimum printing region 83 is smaller than the entirety of the printing table 43. In order to print the relatively small three-dimensional object 92 as shown in FIG. 4, it is not necessary to form the powder layer 81 on the entirety of the printing table 43. It is sufficient to form the powder layer 81 only in, and around, the minimum printing region 83. Nonetheless, a conventional three-dimensional printing device always forms the powder layer on the entirety of a printing table, and always requires the same amount of the powder material, even in order to print a relatively small object. In the case where a large amount of the powder material is used, a large amount of labor is needed to prepare for the printing and to perform processing after the printing. In addition, an uncured portion of the powder material that was located outside the curing region and thus was not consumed is not all reusable, which increases the consumption of the powder material.

In such a situation, the three-dimensional printing device 10 in this preferred embodiment supplies a smaller amount of the powder material 80 than in the case where the powder layer is formed on the entirety of the printing table 43, and to adjust the amount of the powder material 80 in accordance with the size of the three-dimensional object 92. The three-dimensional printing device 10 in this preferred embodiment includes the region input 103, by which a region where the powder layer 81 is to be formed may be designated. The powder material 80 is supplied onto the printing table 43 in an amount with which the power layer 81 is formed in a region designated by the region input 103. The powder material 80 supplied in such an amount is levelled off on the printing table 43, and thus the powder layer 81 is formed in the region set by the region input 103.

Hereinafter, a method for printing a three-dimensional object 92 by the three-dimensional printing device 10 in this preferred embodiment will be described, in comparison with a conventional method optionally. In this preferred embodiment, the user designates a length Lx2 of the powder layer 81 in the feeding direction X by use of the region input 103. In the case shown in FIG. 4, it is preferred that the length Lx2 is a sum of the length Lx of the minimum printing region 83 in the feeding direction X and a slight margin. It should be noted that the length Lx2 may be set to any value by the user. After the length Lx2 is set, the printing is started.

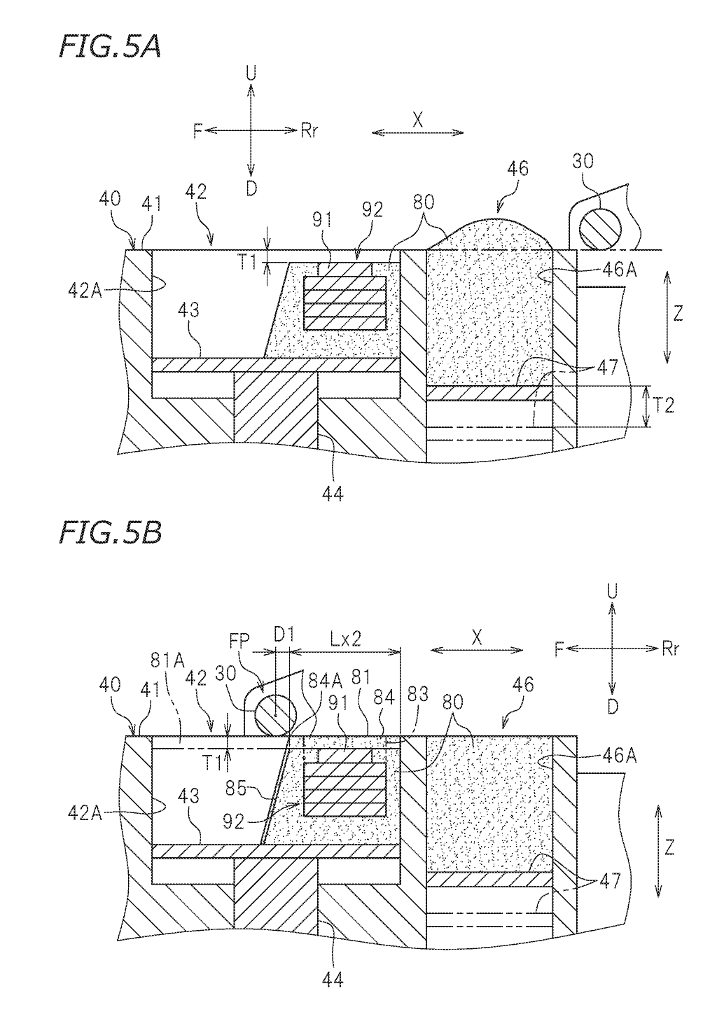

FIGS. 5A and 5B are schematic cross-sectional views of the printing tank 42, the supply tank 46 and the vicinity thereof, showing a step of forming the powder layer 81. FIG. 5A shows a state where one cured layer 91 is formed and before the powder material 80 in the supply tank 46 is transferred onto the printing table 43. FIG. 5B shows a state after the state shown in FIG. 5A, more specifically, after the powder layer 81 is newly formed on the printing table 43.

As shown in FIG. 5A, a top surface of the uppermost cured layer 91 is below the bottom surface of the spreading roller 30 by a height T1. This is because after the uppermost cured layer 91 is formed, the supply controller 102 causes the printing table 43 to be lowered by the height T1. Namely, each time one cured layer 91 is formed, the supply controller 102 controls the table elevator 45 such that the printing table 43 is lowered by the height T1. The height T1 is a thickness of the powder layer 81 formed in the step shown in FIG. 5B.

In addition to causing the printing table 43 to be lowered by the height T1, the supply controller 102 controls the supply tank elevator 48 such that the bottom 47 of the supply tank 46 is raised by a height T2. As shown in FIG. 5A, along with the rise of the bottom 47, the powder material 80 stored in the storage space 46A partially overflows the supply tank 46 and protrudes from the supply tank 46. The height T2, by which the bottom 47 is raised, is based on the supply amount of the powder material 80 set by the supply amount setter 104. More specifically, where the volume of the powder material 80 set by the supply amount setter 104 is V1 and the area size of the supply tank 46 (or the bottom 47) as seen in a plan view is S1, the height T2 fulfills V1=S1×T2.

After causing the printing table 43 to be lowered and causing the bottom 47 of the supply tank 46 to be raised, the supply controller 102 controls the feeding direction conveyor 20 such that the printing tank unit 40 is moved rearward. Since the printing tank unit 40 is moved rearward, the spreading roller 30 is moved forward with respect to the printing tank 42 and the supply tank 46. As shown in FIG. 5B, as a result of such a relative movement of the spreading roller 30, the powder material 80 protruding from the supply tank 46 is levelled off to be aligned with the bottom surface of the spreading roller 30. The relative movement of the spreading roller 30 is continued until the spreading roller 30 reaches a formation finish position FP shown in FIG. 5B. The formation finish position FP is on the printing table 43, and the powder layer 81 is formed to the rear of the formation finish position FP.

As shown in FIG. 5B, the powder layer 81 includes a portion including a flat surface (flat portion 84), and a portion including an inclination surface (inclination portion 85). Ideally, a front end 84A of the flat portion 84 is aligned with a front end of the powder layer 81 formed immediately previously in the feeding direction X. The length of the flat portion 84 in the feeding direction X is Lx2. Namely, the length Lx2 of the powder layer 81 in the feeding direction X that is set by use of the feeding direction input 103x is the length of the flat portion 84 in the feeding direction X. To the front of the front end 84A of the flat portion 84, the powder layer 81 slopes down in accordance with the angle of repose of the powder material 80 to form the inclination portion 85. The flat portion 84 includes the minimum printing region 83 of the three-dimensional object 92.

The powder material 80 supplied from the supply tank 46 forms the powder layer 81 on the printing table 43, namely, forms the flat portion 84 and the inclination portion 85. Therefore, the sum of a volume V2 of the flat portion 84 and a volume V3 of the inclination portion 85 is equal to the volume V1 of the powder material 80 supplied from the supply tank 46. Namely, V1=V2+V3. The volume V1 is calculated by the supply amount computation processor 104A based on the length Lx2 of the flat portion 84 in the feeding direction X. The volume V2 of the flat portion 84 and the volume V3 of the inclination portion 85 are able to be calculated as long as the angle of repose of the powder material 80 is known. Therefore, the volume V1 of the powder material 80 thus supplied is able to be calculated. Supply of the powder material 80 in the supply amount V1 calculated by the supply amount computation processor 104A naturally results in the formation of the powder layer 81, the flat portion 84 of which has the length Lx2 in the feeding direction X.

As shown in FIG. 5B, the formation finish position FP, at which the spreading roller 30 is located when the formation of the powder layer 81 is finished, is located slightly to the front of the front end 84A of the flat portion 84. A distance D1 between the front end 84A of the flat portion 84 and the formation finish position FP of the spreading roller 30 is an overrun distance that is set in order to guarantee that the formation of the flat portion is completed without fail. The three-dimensional printing device 10 in this preferred embodiment stops the relative movement of the spreading roller 30 (movement of the printing tank unit 40) at the position having a total distance of the length Lx2 of the powder layer 81 and the overrun distance D1 from a rear end of the printing space 42A.

By contrast, in the case where the powder layer 81 is formed by a conventional method, some waste that is not caused in this preferred embodiment is caused. In FIG. 5B, reference sign 81A represents a powder layer formed by a conventional three-dimensional printing device. The volume of one powder layer 81A is equal to a volume determined as a result of the area size of the printing table 43 being multiplied by the height T1. As described above, the conventional three-dimensional printing device forms the powder layer 81A on the entirety of the printing table 43 regardless of the size of the three-dimensional object 92. As shown in FIG. 5B, the powder layer 81A formed by the conventional three-dimensional printing device is larger than the powder layer 81 formed in this preferred embodiment. The three-dimensional printing device 10 in this preferred embodiment decreases the amount of the powder material 80 needed for the printing as compared with the conventional three-dimensional printing device, by a volume determined as a result of the difference in the volume between the two types of powder layers being multiplied by the number of the powder layers to be formed by each three-dimensional printing device.

In this preferred embodiment, the spreading roller 30 is moved only to the formation finish position FP in order to form the powder layer 81. In the conventional three-dimensional printing device, the spreading roller is moved to at least a position to the front of a front end of the printing tank. Therefore, the time required to spread the powder material 80 is longer than in this preferred embodiment. The time required to print one three-dimensional object by the conventional three-dimensional printing device is longer than the time required in this preferred embodiment, by a time duration determined as a result of the difference in the time per powder layer being multiplied by the number of the powder layers. Therefore, especially in the case where the number of the powder layers to be formed is large, the productivity of the three-dimensional printing device 10 in this preferred embodiment is higher.

As described above, the three-dimensional printing device 10 in this preferred embodiment supplies the powder material 80 in a smaller amount than in the case where a powder layer is formed on the entirety of the printing table 43, so that the powder layer 81 including the flat portion 84 smaller than the printing table 43 may be formed. This decreases the amount of the powder material 80 required for the printing. More specifically, the three-dimensional printing device 10 in this preferred embodiment sets the length Lx2 of the formation region of the powder layer 81 in the feeding direction X. The three-dimensional printing device 10 sets the length Lx2 appropriately in accordance with the size of the three-dimensional object 92 to be printed, so that the required amount of the powder material 80 is able to be decreased. In addition, according to the three-dimensional printing device 10 in this preferred embodiment, in order to form the powder layer 81, the spreading roller 30 does not necessarily move to the end of the printing tank 42 in the advancing direction (in this preferred embodiment, to the front end of the printing tank 42) but stops at the formation finish position FP, which has a total distance of the length Lx2 and the overrun distance D1 from the rear end of the printing space 42A. This decreases the time required to form the powder layer 81 by the spreading roller 30, which improves the productivity.

After the powder layer 81 is formed as described above, the curing liquid is ejected from the ejection heads 52 toward the cured layer 81 to cure the powder material 80 such that the powder material 80 of the powder layer 81 has a desired cross-sectional shape. As a result, the cured layer 91 is formed. After one cured layer 91 is formed, the formation of such powder layers 81 is repeated. The formation of the powder layer 81 and the formation of the cured layer 91 are repeated to form the three-dimensional object 92 in the printing tank 42.

In this preferred embodiment, the length Lx2 of the powder layer 81 in the feeding direction X is input to the feeding direction input 103x. The present invention is not limited to this preferred embodiment. For example, the position of a front end of the powder layer 81 may be directly input to a screen that displays the curing region 82. There is no limitation on the method for designating the formation region of the powder layer 81.

### Preferred Embodiment 2

In preferred embodiment 2, the length of the formation region of the powder layer 81 is designated also in the scanning direction Y. This preferred embodiment is the same as preferred embodiment 1 except for this point. In the description of this preferred embodiment, elements that are the same as those in preferred embodiment 1 will bear the identical reference signs thereto, and overlapping descriptions will be omitted or simplified.

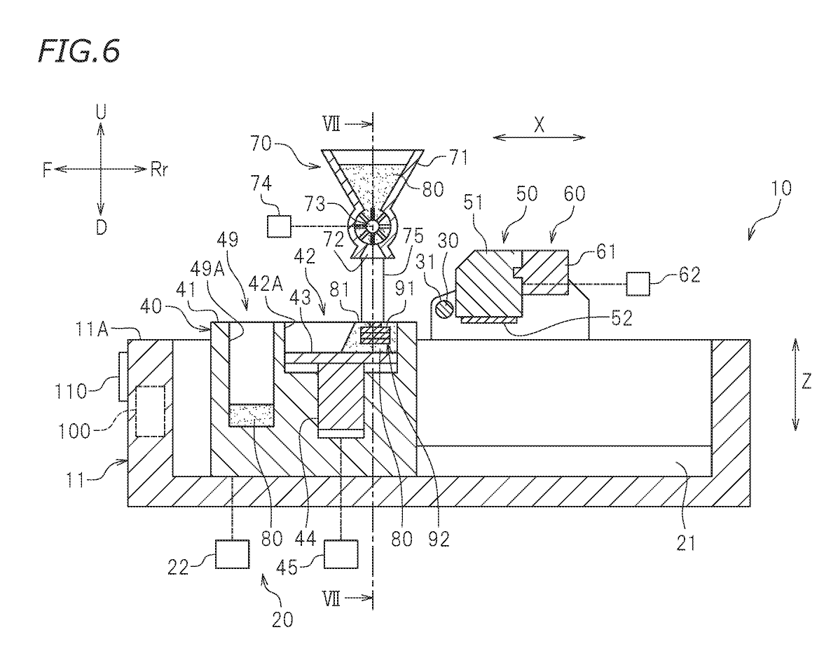

FIG. 6 is a schematic cross-sectional view of a three-dimensional printing device 10 in this preferred embodiment. As shown in FIG. 6, the three-dimensional printing device 10 in this preferred embodiment includes neither the supply tank 46 nor the members related thereto (bottom 47, supply tank elevator 48) shown in FIG. 1 or FIG. 2 but includes a powder supply member 70. The powder supply member 70 drops and thus supplies the powder material 80 onto the printing table 43 from above.

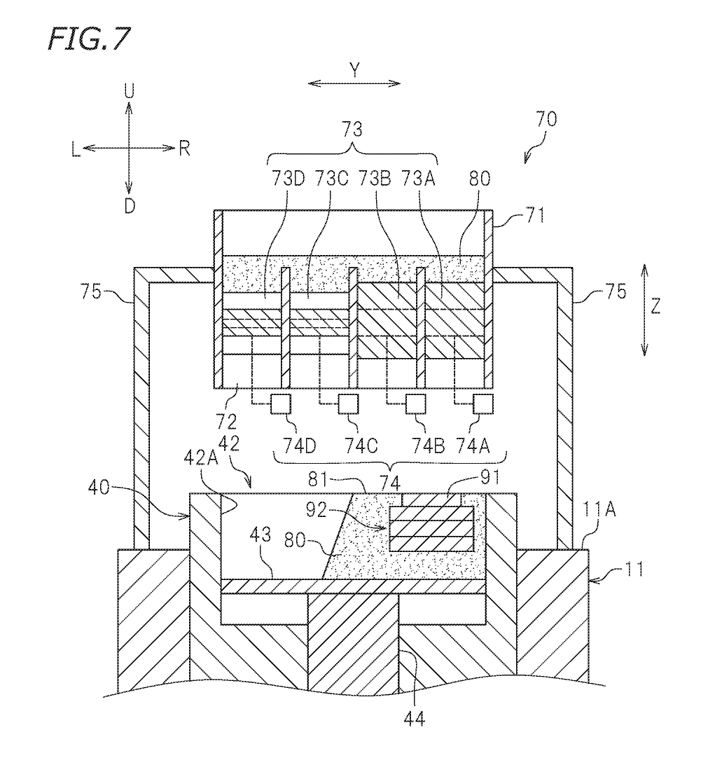

As shown in FIG. 6, the powder supply member 70 is provided above the printing tank unit 40. The powder supply member is located to the front of the head unit 50. The cross-sectional view shown in FIG. 7 is taken along line VII-VII in FIG. 6. As shown in FIG. 6 and FIG. 7, the powder supply member 70 includes a storage tank 71 and four rotary valves 73.

The powder material 80 is stored in the storage tank 71. The storage tank 71 is located above the printing tank unit 40. A support 75 extending upward is provided on the top surface 11A of the main body 11. The storage tank 71 is supported by the support 75. The storage tank 71 is opened upward. As shown in FIG. 6, the length of the storage tank 71 in the front-rear direction X is longest at a top portion thereof and is decreased toward a bottom portion thereof. The storage tank 71 has a cylindrical shape at a height where the rotary valves 73 are provided.

As shown in FIG. 6, a supply opening 72 opened downward is located in a bottom surface of the storage tank 71. The powder material 80 in the storage tank 71 is supplied onto the printing table 43 in the printing tank 42 via the supply opening 72. As shown in FIG. 7, the supply opening 72 extends in the scanning direction Y. The supply opening 72 is located at the same position as that of the printing tank 42 in the scanning direction Y. The length of the supply opening 72 in the scanning direction Y is equal to the length of the printing tank 42 in the scanning direction Y.

The rotary valves 73 supply the powder material 80 in the storage tank 71 into the printing space 42A of the printing tank 42. As shown in FIG. 7, the four rotary valves 73A through 73D are arrayed in the scanning direction Y. In more detail, the rotary valve 73A, the rotary valve 73B, the rotary valve 73C and the rotary valve 73D are arrayed in this order from the right. The rotary valves 73A through 73D are located in the storage tank 71 as being buried in the powder material 80. As shown in FIG. 6, blades of the rotary valves 73 inscribe the cylindrical portion of the storage tank 71. The plurality of rotary valves 73A through 73D are respectively connected with supply motors 74A through 74D, which are independent from each other. The supply motors 74A through 74D are each electrically connected with the controller 100. The supply motors 74A through 74D are structured to be controlled independently from each other. For example, when one supply motor 74 is driven, the rotary valve 73 corresponding thereto is rotated. Along with the rotation of the rotary valve 73, a portion of the powder material 80 is supplied into the printing space 42A of the printing tank 42 via the supply opening 72. Since the plurality of rotary motors 74A through 74D are independently controlled, the plurality of rotary valves 73 also supply the powder material 80 independently.

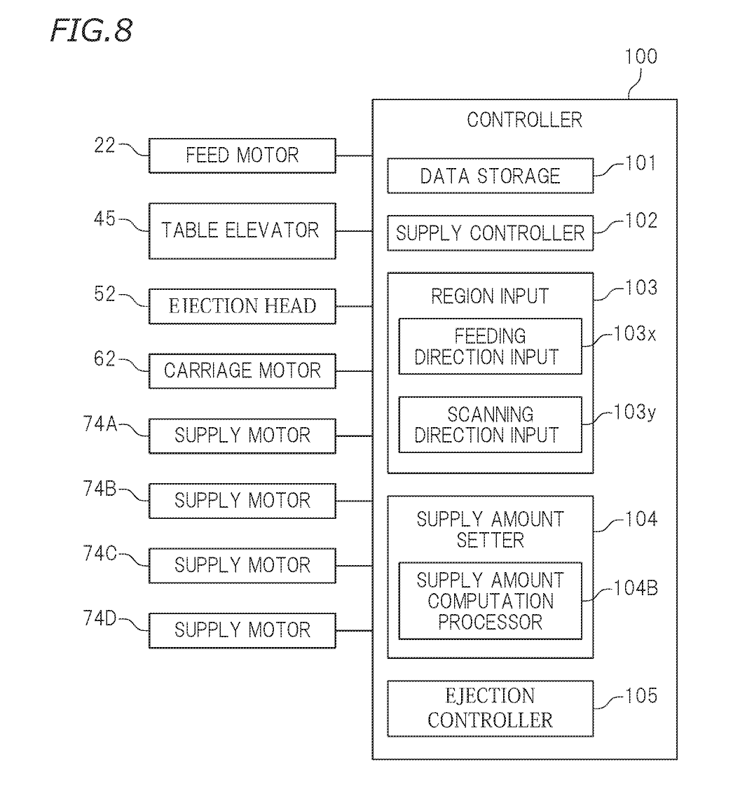

FIG. 8 is a block diagram of the three-dimensional printing device 10 in this preferred embodiment. As shown in FIG. 8, the region input 103 in this preferred embodiment includes a scanning direction input 103y in addition to the feeding direction input 103x. The scanning direction input 103y is a portion to which a length of the powder layer 81 in the scanning direction Y is to be input. In this preferred embodiment, the supply amount setter 104 includes a supply amount computation processor 104B. The supply amount computation processor 104B in this preferred embodiment has different specifications from those of the supply amount computation processor 104A in preferred embodiment 1. The supply amount computation processor 104B in this preferred embodiment computes an amount of the powder material 80 needed to form the powder layer 81 in a region designated in the feeding direction X and the scanning direction Y.

Regarding the scanning direction Y, the formation region of the powder layer 81 is set by designating the rotary valve 73 to supply the powder material 80. In the case where, for example, the rotary valve 73A located at the rightmost position is rotated and the powder material 80 is dropped to a region just below the rotary valve 73A, the powder material 80 is supplied only to a rightmost quarter region of the printing table 43. Similarly, in the case where the rotary valves 73A and 73B are rotated and the powder material 80 is dropped to a region just below the rotary valves 73A and 73B, the powder material 80 is supplied to a right half region of the printing table 43. In the case where the rotary valves 73A, 73B and 73C are rotated and the powder material 80 is dropped to a region just below the rotary valves 73A, 73B and 73C, the powder material 80 is supplied to a right three-quarter region of the printing table 43. In the case where all the four rotary valves 73A through 73D are rotated and the powder material 80 is dropped to a region just below the rotary valves 73A through 73D, the powder material 80 is supplied to the entirety of the printing table 43 in the scanning direction Y.

The supply amount computation processor 104B in this preferred embodiment calculates a supply amount of the powder material 80 for each of the rotary valves 73. The amount of the powder material 80 to be supplied by one rotary valve 73 is computed based on the length Lx2 of the powder layer 81 in the feeding direction X. The method of computation is the same or substantially the same as in preferred embodiment 1. The supply controller 102 causes the powder material 80 to be supplied in the amount calculated by the supply amount computation processor 104B to the corresponding rotary valve 73. In actuality, the supply amount is managed based on, for example, the rotation time of the rotary valve 73, the measured weight of the powder material 80, and the like. Then, the feeding direction conveyor 20 moves the spreading roller 30 with respect to the printing table 43, and the powder layer 81 is formed in the region supplied with the powder material 80 by the powder supply member 70 and a region to the front thereof. This step is the same or substantially the same as in preferred embodiment 1.

As described above, the three-dimensional printing device 10 in this preferred embodiment designates the formation region of the powder layer 81 both regarding the feeding direction X and the scanning direction Y, so that the powder layer 81 is able to be formed. The formation region of the powder layer 81 is designated regarding the scanning direction Y as well as the feeding direction X, so that the amount of the powder material 80 needed for the printing is further decreased. In this preferred embodiment, a mechanism of supplying the powder material 80 only to a designated region is adopted in order to restrict the formation region of the powder layer 81 regarding the scanning direction Y. With this mechanism, the three-dimensional printing device 10 in this preferred embodiment is able to form the powder layer 81 as designated also regarding the scanning direction Y.

In this preferred embodiment, the powder supply member 70 located above the printing table 43 and capable of adjusting the position to which the powder material 80 is to be dropped is proposed as a member that supplies the powder material 80 to a desired position in the scanning direction Y. Such a powder supply member has a simple structure and operates without fail.

The powder supply member capable of adjusting the region, in the scanning direction Y, to which the powder material 80 is to be supplied is not limited to the above-described member. For example, a powder supply member that drops the powder material 80 from above like the above-described member may be provided with a plurality of supply openings arrayed in the scanning direction Y and openable/closable independently. A powder supply member may include a shutter capable of adjusting a position at which the supply opening extending in the scanning direction Y is closed. Alternatively, a powder supply member may be provided with a plurality of supply tanks, like the supply tank in preferred embodiment 1, that are arrayed in the scanning direction Y and independently controlled. There is no limitation on the structure of the powder supply member.

### Preferred Embodiment 3

In preferred embodiment 3 of the present invention, the formation region of the powder layer 81 is automatically set based on the printing data on the three-dimensional object 92 stored on the data storage 101. In the description of this preferred embodiment also, elements that are the same as those in preferred embodiments 1 and 2 will bear the identical reference signs thereto, and overlapping descriptions will be omitted or simplified.

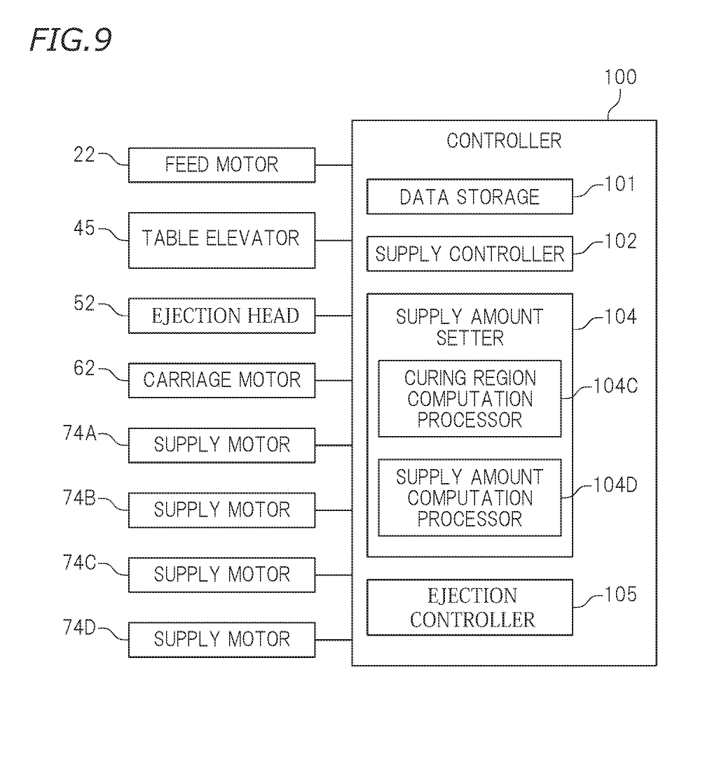

FIG. 9 is a block diagram of a three-dimensional printing device 10 in this preferred embodiment. In this preferred embodiment, the controller 100 does not include the region input 103 but includes a curing region computation processor 104C in the supply amount setter 104. A supply amount computation processor 104D has different specifications from those of the supply amount computation processor 104A in preferred embodiment 1 or the supply amount computation processor 104B in preferred embodiment 2.

The curing region computation processor 104C specifies a curing region 82 (see FIG. 4) based on the printing data stored on the data storage 101. The curing region 82 is the same as that in preferred embodiment 1, but in this preferred embodiment, the curing region 82 is determined by the three-dimensional printing device 10, with no operation being made by the user.

The supply amount computation processor 104D in this preferred embodiment determines a preferred formation region of the powder layer 81, based on the curing region 82 determined by the curing region computation processor 104C. Then, the supply amount computation processor 104D calculates the supply amount of the powder material 80 needed to form the powder layer 81 in the region. There is no limitation on the method for determining the formation region of the powder layer 81. In this preferred embodiment, for example, the minimum printing region 83 (see FIG. 4) is first set, and then a margin region is provided to the front, rear, left and right of the minimum printing region 83.

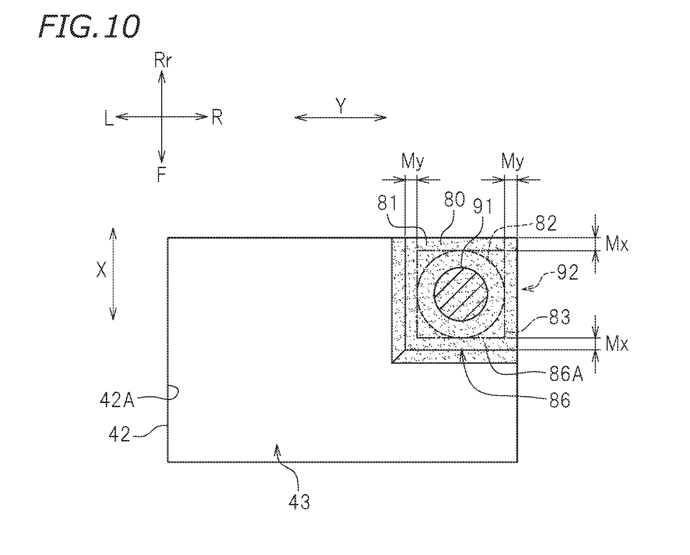

FIG. 10 is a schematic view showing a formation region of the powder layer 81 in this preferred embodiment. The formation region 86 shown in FIG. 10 is set by the supply amount computation processor 104D. As shown in FIG. 10, the formation region 86 includes the minimum printing region 83 and a margin region 86A around the minimum printing region 83. A left portion and a right portion of the margin region 86A each have a margin length My in the left-right direction Y. Alternatively, the left portion and the right portion may have different lengths. A front portion and a rear portion of the margin region 86A each have a margin length Mx in the front-rear direction X. Alternatively, the front portion and the rear portion may have different lengths. The margin length My in the scanning direction Y and the margin length Mx in the feeding direction X may be equal to, or different from, each other. The margin length Mx and the margin length My are preset. Alternatively, the three-dimensional printing device 10 may be structured such that the margin lengths are changeable by the user optionally.

The three-dimensional printing device 10 in this preferred embodiment has substantially the same mechanical structure as that in preferred embodiment 2. Like in preferred embodiment 2, the three-dimensional printing device 10 in this preferred embodiment controls the plurality of rotary valves 73 independently to supply the powder material 80 in a desired amount to a desired position in the scanning direction Y. The supplied powder material 80 is levelled off by the spreading roller 30, and the powder layer 81 is formed in the formation region automatically set on the printing table 43. In this preferred embodiment, the length of the formation region 86 in the scanning direction Y is selected step by step by the control by the rotary valve 73, like in preferred embodiment 2. Thus, the supply amount computation processor 104D selects the length of the formation region 86 in the scanning direction Y such that the length is minimum while including the length of the minimum printing region 83 and the margin length My.

As described above, in the three-dimensional printing device 10 in this preferred embodiment, the formation region 86 of the powder layer 81 is automatically set based on the printing data on the three-dimensional object 92. Therefore, the formation region 86 is set without fail and appropriately. Especially because the predetermined margin region 86A is provided outer to the minimum printing region 83, a risk that the position of the border between the flat portion 84 and the region outer thereto is slightly varied due to the state of the powder material 80 or the like is alleviated. The automatic setting of the formation region 86 by the three-dimensional printing device 10 in this preferred embodiment does not require a work of the user and thus is efficient.

In this preferred embodiment, the function of automatically setting the formation region 86 of the powder layer is provided instead of the function of causing the user to designate the formation region of the powder layer 81. Alternatively, the automatic setting function may be provided in addition added to the function of causing the user to designate. Namely, the function of causing the user to designate the formation region of the powder layer 81 and the function of automatically setting the formation region 86 of the powder layer 81 may be both provided, so that either one is usable. In this preferred embodiment, the three-dimensional printing device 10 in preferred embodiment 2 is changed such that the formation region 86 of the powder layer 81 is automatically set. Alternatively, the three-dimensional printing device 10 in preferred embodiment 1 may be changed such that the formation region 86 of the powder layer 81 is automatically set. In such a case, the formation region 86 of the powder layer 81 is fixed in the printing table 43 regarding the scanning direction Y and is automatically set only regarding the feeding direction X.

Some preferred embodiments of the present invention are described above. The above-described preferred embodiments are merely examples, and the present invention may be carried out in any of various other forms.

For example, in the above-described preferred embodiments, the formation region of the powder layer 81 is set to be rectangular or substantially rectangular starting from one corner of the printing table 43 (in the above-described preferred embodiments, right rear corner). The present invention is not limited to this. The formation region of the powder layer 81 may be anywhere on the printing table 43, and do not need to include a corner or an outer perimeter of the printing table 43. The formation region does not need to be rectangular or substantially rectangular. The formation region does not need to be one closed region, and may include a plurality of closed regions. There is no limitation on the formation region for the powder layer 81 except that the formation region needs to include at least the curing region 82.

In the above-described preferred embodiments, the member forming the powder layer 81 is the spreading roller 30. A member that forms the power layer 81 (layer formation member) is not limited to the spreading roller 30. The layer formation member may be, for example, a squeeze or the like. In the above-described preferred embodiments, the relative movement of the printing table 43 and the layer formation member is realized by the movement of the printing table 43. The present invention is not limited to this. For example, the printing tank unit 40 may be secured to the main body 11, whereas the spreading roller 30 or the head unit 50 may be moved in the feeding direction X with respect to the printing tank unit 40. The movements in preferred embodiments of the present invention are all relative, and which of the members is to be movable varies in accordance with the preferred embodiments.

In the above-described preferred embodiments, the powder material 80 is cured by the curing liquid ejected thereto. The present invention is not limited to this. The powder material 80 may be cured by any method. Any of various known technologies is usable; for example, the powder material 80 may be irradiated with laser light to be cured.

The present invention is not limited to the three-dimensional printing devices according to preferred embodiments as described above, but encompasses methods for printing a three-dimensional object including substantially the same steps performed by the user. Such a method, specifically, is a method for printing a three-dimensional object by curing a powder material on a printing table, the method including a first step of measuring the powder material; a second step of levelling off the measured powder material to form a powder layer including a flat portion having a predetermined height on the printing table; and a third step of curing the powder material of the powder layer to form the three-dimensional object. The amount of the powder material to be measured is smaller than an amount corresponding to a volume determined as a result of an area size of the printing table being multiplied by the predetermined height; the flat portion has an area size smaller than the area size of the printing table; and the three-dimensional object is formed by curing the powder material of the flat portion. For example, the powder material may be measured by the user by use of an external device. The position where the three-dimensional object is to be printed may be determined after the powder layer is formed, in accordance with the position of the powder layer. Such a method provides the substantially the same function and effect as those of the method performed by the above-described three-dimensional printing device.

The terms and expressions used herein are for description only and are not to be interpreted in a limited sense. These terms and expressions should be recognized as not excluding any equivalents to the elements shown and described herein and as allowing any modifications encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing device curing a powder material to print a three-dimensional object, three-dimensional printing device comprising:
a printing table;
a material supplier that supplies the powder material;
a layer former that levels off the supplied powder material to form a powder layer including a flat portion having a predetermined height on the printing table; and
a controller connected with the material supplier and the layer former; wherein
the controller is configured or programmed to include:
a supply controller that controls the material supplier such that the powder material is supplied;
a formation controller that controls the layer former such that the powder layer is formed on the printing table; and
a supply amount setter that sets an amount of the powder material to be supplied from the material supplier;
the supply amount setter is configured or programmed to set, as the amount of the powder material to be supplied, an amount smaller than a reference supply amount corresponding to a volume determined as a result of an area size of the printing table being multiplied by the predetermined height; and
in a case where an amount smaller than the reference supply amount is set as the amount of the powder material to be supplied, the layer former forms the powder layer having the flat portion such that the flat portion has an area size smaller than the area size of the printing table.

2. The three-dimensional printing device according to claim 1, wherein the supply amount setter is configured or programmed to include:
a first computing portion that computes a curing region, on the printing table, where the powder material is to be cured, based on printing data on the three-dimensional object; and
a second computing portion that computes an amount of the powder material needed to form the powder layer including the flat portion such that the flat portion includes the curing region.

3. The three-dimensional printing device according to claim 2, wherein
the first computing portion computes a length of the curing region in a first direction;
the layer former includes:
a layer formation member in contact with the powder material on the printing table, the layer formation member having a length, in a second direction perpendicular to the first direction, that is longer than a length of the printing table in the second direction; and
a conveyor that moves the layer formation member in the first direction with respect to the printing table;
the layer former moves the layer formation member in the first direction to form the powder layer on the printing table; and
the second computing portion computes an amount of the powder material needed to form the powder layer such that the flat portion of the powder layer has a length in the first direction that is longer, by a predetermined length, than the length of the curing region in the first direction and has a length in the second direction that is equal or substantially equal to the length of the printing table in the second direction.

4. The three-dimensional printing device according to claim 2, wherein
the first computing portion computes a length of the curing region in the first direction and a length of the curing region in a second direction perpendicular to the first direction; and
the second computing portion computes an amount of the powder material needed to form the powder layer such that the flat portion of the powder layer has a length in the first direction that is longer, by a predetermined first length, than the length of the curing region in the first direction and has a length in the second direction that is longer, by a predetermined second length, than the length of the curing region in the second direction.

5. The three-dimensional printing device according to claim 4, wherein
the material supplier supplies the powder material to a region where the flat portion is to be formed;
the layer former includes:
a layer formation member extending in the second direction and contacting the powder material on the printing table; and
a conveyor that moves the layer formation member in the first direction with respect to the printing table; and
the layer former moves the layer formation member in the first direction to form the powder layer on the printing table.

6. The three-dimensional printing device according to claim 5, wherein
the material supplier is located above the printing table and includes:
a material discharge opening extending in the second direction such that the powder material is dropped downward via the material discharge opening; and
a supply position adjuster that adjusts a position of the material discharge opening in the second direction; and
the supply controller controls the supply position adjuster such that the powder material is dropped toward the region where the flat portion is to be formed.

7. The three-dimensional printing device according to claim 3, wherein to form the powder layer, the conveyor moves the layer formation member to a position that is spaced away from an end of the flat portion in the first direction by a predetermined distance.

8. The three-dimensional printing device according to claim 5, wherein to form the powder layer, the conveyor moves the layer formation member to a position that is spaced away from an end of the flat portion in the first direction by a predetermined distance.

9. The three-dimensional printing device according to claim 1, wherein:
the controller includes a first input to which a length of the flat portion in the first direction is to be input;
the layer former includes:
a layer formation member in contact with the powder material on the printing table, the layer formation member having a length, in a second direction perpendicular to the first direction, that is longer than a length of the printing table in the second direction; and
a conveyor that moves the layer formation member in the first direction with respect to the printing table;
the layer former moves the layer formation member in the first direction to form the powder layer on the printing table; and
the supply amount setter is configured or programmed to include a third computing portion that computes an amount of the powder material needed to form the powder layer such that the flat portion of the powder layer has a length in the first direction that is equal or substantially equal to the length input to the first input and has a length in the second direction that is equal or substantially equal to the length of the printing table in the second direction.

10. The three-dimensional printing device according to claim 1, wherein
the controller is configured or programmed to include:
a first input to which a length of the flat portion in a first direction is to be input;
a second input to which a length of the flat portion in a second direction is to be input; and
the supply amount setter is configured or programmed to include a fourth computing portion that computes an amount of the powder material needed to form the powder layer such that the flat portion of the powder layer has a length in the first direction that is equal or substantially equal to the length input to the first input and has a length in the second direction that is equal or substantially equal to the length input to the second input.

11. The three-dimensional printing device according to claim 10, wherein
the material supplier supplies the powder material to a region where the flat portion is to be formed;
the layer former includes:
a layer formation member extending in the second direction and contacting the powder material on the printing table; and
a conveyor that moves the layer formation member in the first direction with respect to the printing table; and
the layer former moves the layer formation member in the first direction to form the powder layer on the printing table.

12. The three-dimensional printing device according to claim 11, wherein
the material supplier is located above the printing table and includes:
a material discharge opening extending in the second direction such that the powder material is dropped downward via the material discharge opening; and
a supply position adjuster that adjusts a position of the material discharge opening in the second direction; and
the supply controller controls the supply position adjuster such that the powder material is dropped toward the region where the flat portion is to be formed.

13. The three-dimensional printing device according to claim 9, wherein to form the powder layer, the conveyor moves the layer formation member to a position that is spaced away from an end of the flat portion in the first direction by a predetermined distance.

14. The three-dimensional printing device according to claim 11, wherein to form the powder layer, the conveyor moves the layer formation member to a position that is spaced away from an end of the flat portion in the first direction by a predetermined distance.

15. A method for printing a three-dimensional object by curing a powder material on a printing table, the method comprising:
a first step of measuring the powder material;
a second step of levelling off the measured powder material to form a powder layer including a flat portion having a predetermined height on the printing table; and
a third step of curing the powder material of the powder layer to form the three-dimensional object; wherein
an amount of the powder material to be measured is smaller than an amount corresponding to a volume determined as a result of an area size of the printing table being multiplied by the predetermined height;
the flat portion has an area size smaller than the area size of the printing table; and
the three-dimensional object is formed by curing the powder material of the flat portion.
